(19) United States
(12) Patent Application Publication
(10) Pub. No.: US 2025/0300223 A1
(43) Pub. Date: Sep. 25, 2025

(54) COMPOSITION FOR GEL POLYMER ELECTROLYTE, GEL POLYMER ELECTROLYTE AND ELECTROCHEMICAL DEVICE COMPRISING THE SAME

(71) Applicant: University of Seoul Industry Cooperation Foundation, Seoul (KR)

(72) Inventors: Cheolsoo Jung, Seoul (KR); Young-il Shin, Namyangju-si (KR)

(73) Assignee: University of Seoul Industry Cooperation Foundation, Seoul (KR)

(21) Appl. No.: 19/085,259

(22) Filed: Mar. 20, 2025

(30) Foreign Application Priority Data
Mar. 20, 2024 (KR) 10-2024-0038381

(51) Int. Cl. H01M 10/0565

(52) U.S. Cl. CPC H01M 10/0565; H01M 2300/0082

(57) ABSTRACT

The present specification relates to a composition for a gel polymer electrolyte, a gel polymer electrolyte, and an electrochemical device including the same, and the gel polymer electrolyte according to one aspect of the present specification may simultaneously form a stable SEI layer while exhibiting high ionic conductivity, low charge transfer resistance, and elastic properties, and an electrochemical device to which such a gel polymer electrolyte is applied may exhibit high stability and excellent electrochemical performance. The gel polymer electrolyte according to one aspect of the present specification may be applied to various electrochemical devices such as lithium ion batteries and thermoelectric devices.

### CROSS REFERENCE TO RELATED APPLICATION

The present application claims priority to Korean Patent Application No. 10-2024-0038381, filed Mar. 20, 2024, the entire contents of which are hereby incorporated by this reference.

### BACKGROUND OF THE INVENTION

### Field of the Invention

The present specification relates to a composition for a gel polymer electrolyte, a gel polymer electrolyte, and an electrochemical device including the same.

### Description of the Related Art

Recently, there has been an increasing interest in energy storage and conversion technologies, and attention has focused on various types of electrochemical devices such as batteries, supercapacitors, and electronic skin. Although liquid electrolytes have been mainly used in electrochemical devices in the related art, there is a problem in that the driving of the device becomes unstable due to not only the possibility of liquid leakage, but also the volatility and instability of the solvent. To solve this problem, research and development of gel polymer electrolytes to replace liquid electrolytes have been actively conducted. However, gel polymer electrolytes have a limitation in that their electrochemical properties are inferior to those of liquid electrolytes. Therefore, there is a need for the research and development of a gel polymer electrolyte capable of improving leakage resistance and stability and simultaneously having excellent electrochemical properties.

### SUMMARY OF THE INVENTION

An object of one aspect of the present specification is to provide a composition for a polymer electrolyte (or gel polymer electrolyte).

An object of one aspect of the present specification is to provide a gel polymer electrolyte having excellent electrochemical properties and stable driving.

An object of another aspect of the present specification is to provide an electrochemical device having excellent electrochemical properties and high stability.

An object of still another aspect of the present specification is to provide a method for preparing a gel polymer electrolyte.

A composition for a polymer electrolyte (or gel polymer electrolyte) according to one aspect of the present specification includes: an electrolyte salt including lithium difluoro (oxalato) borate (LiDFOB); and
a first monomer selected from an acrylate-based compound including an isocyanate group and a methacrylate-based compound including an isocyanate group.

A gel polymer electrolyte according to an aspect of the present specification is prepared by the composition for a gel polymer electrolyte.

An electrochemical device according to an aspect of the present specification includes the gel polymer electrolyte.

A method for preparing a gel polymer electrolyte according to one aspect of the present specification includes: curing a precursor composition of the gel polymer electrolyte.

A gel polymer electrolyte exhibiting improved leakage resistance and stability and excellent electrochemical properties can be prepared using the composition for a gel polymer electrolyte according to one aspect of the present specification. The composition for a gel polymer electrolyte according to one aspect of the present specification can be injected and cured in situ.

The gel polymer electrolyte according to one aspect of the present specification has improved leakage resistance and stability, and simultaneously exhibits excellent electrochemical properties.

The gel polymer electrolyte according to one aspect of the present specification can simultaneously form a stable SEI layer while exhibiting high ionic conductivity, low charge transfer resistance, and elastic properties. An electrochemical device to which the gel polymer electrolyte according to one aspect of the present disclosure is applied can exhibit high stability and excellent electrochemical performance.

### BRIEF DESCRIPTION OF THE DRAWINGS

FIG. 1 is a graph illustrating the physical properties of a gel polymer electrolyte depending on the contents of monomers in a pre-gel.

FIG. 2 illustrates a set of photographs of gel polymer electrolytes whose physical properties differ depending on the contents of monomers in the pre-gel.

FIGS. 3A and 3B are graphs illustrating the physical properties measured by UTM after coating a cellulose separator and a PE separator with a gel polymer electrolyte according to one aspect.

FIG. 4 illustrates the results of the LUMO levels and HOMO levels of the main components (EC, DEC, ICEMA, LiDFOB, and DFOB⁻) of the composition for a gel polymer electrolyte and the gel polymer electrolyte according to one aspect of the present specification, calculated by Chemdraw.

FIG. 5 is a graph illustrating the initial discharge capacity and initial capacity retention rate of gel polymer electrolyte cells with different types and contents of electrolyte salts.

FIG. 6 is a graph illustrating the discharge capacity of gel polymer electrolyte cells with different types and contents of electrolyte salts.

FIG. 7 is a graph illustrating the rate of change in capacity depending on the change in voltage under the initial charging conditions of gel polymer electrolyte cells with different types and contents of electrolyte salts.

FIG. 8 is a graph illustrating electrochemical impedance spectroscopy parameters of gel polymer electrolyte cells with different types and contents of electrolyte salts.

FIG. 9 is a graph illustrating the impedance analysis results of gel polymer electrolyte cells with different types and contents of electrolyte salts.

FIG. 10 is a graph illustrating the ionic conductivity of PE separators with gel polymer electrolytes with different types and contents of electrolyte salts, measured using a SS|SS symmetric cell.

FIG. 11 is a graph illustrating the charge/discharge behavior of gel polymer electrolyte cells with different concentrations of a first monomer.

FIG. 12 is a graph illustrating the initial charge/discharge behavior of NCM622|Graphite|Graphite three-electrode pouch cells to which gel polymer electrolytes with different types of electrolyte salts are applied.

FIG. 13 is a graph illustrating the initial charge/discharge behavior of NCM622|Graphite|Graphite three-electrode pouch cells to which gel polymer electrolytes with different types of electrolyte salts are applied.

### DETAILED DESCRIPTION OF THE INVENTION

The examples of the present invention disclosed in the present specification are exemplified for the purpose of describing the examples of the present disclosure only, and the examples of the present invention may be carried out in various forms and should not be construed to be limited to the examples described herein. Since the present invention may have various changes and different forms, it should be understood that the Examples are not intended to limit the present invention to specific disclosure forms and they include all the changes, equivalents and replacements included in the spirit and technical scope of the present invention.

### DEFINITION OF TERMS

When one part “includes” one constituent element in the present specification, unless otherwise specifically described, this does not mean that another constituent element is excluded, but means that another constituent element may be further included.

As used herein, the terms “a combination thereof” and “at least one selected from the group consisting of ˜” refer to a mixture or combination of one or more selected from the group consisting of constituent elements described in the Markush type expression, and means including one or more selected from the group consisting of the above-described constituent elements.

As used herein, the term “composition for a gel polymer electrolyte” may refer to a precursor material for a gel polymer electrolyte, and may also be called as a pre-gel composition. Further, the composition for a gel polymer electrolyte may also be called as a gel precursor composition or a precursor composition of a gel polymer electrolyte.

The composition for a gel polymer electrolyte may be polymerized, cured, and/or polymerized in situ to form a gel polymer electrolyte. The composition for a gel polymer electrolyte may be in the form of a liquid, and may be cured after being injected into a battery.

### DESCRIPTION OF EXEMPLARY EMBODIMENTS

### Composition for Gel Polymer Electrolyte

One aspect of the present specification provides a composition for a gel polymer electrolyte, including: an electrolyte salt including lithium difluoro (oxalato) borate (LiDFOB); and an acrylate-based or methacrylate-based first monomer including an isocyanate group. One aspect of the present specification provides a composition for a gel polymer electrolyte, including: an electrolyte salt including lithium difluoro (oxalato) borate (LiDFOB); and a first monomer selected from an acrylate-based compound including an isocyanate group or a methacrylate-based compound including an isocyanate group.

Gel polymer electrolytes, which include a polymer or copolymer of an acrylate-based or methacrylate-based first monomers (for example: ICEMA) including an isocyanate group, have excellent ionic conductivity and physical properties (for example: viscosity, elasticity, and the like) to a certain level or more, but when applied to lithium-ion batteries, an unstable solid electrolyte interface (SEI) layer may be formed, thereby causing a problem with reduced cell performance (for example: charge and/or discharge performance).

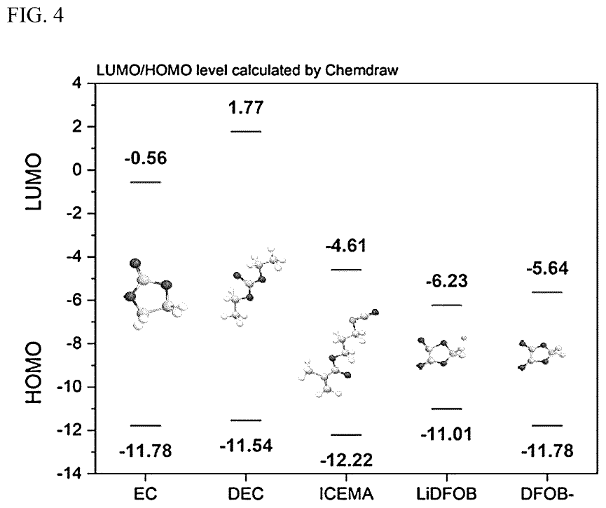

The acrylate-based or methacrylate-based first monomer including an isocyanate group has a lower LUMO level than ethylene carbonate (EC), which is the cause of SEI formation in existing commercial liquid electrolytes, and thus may be reduced first to form an SEI layer, and the SEI thus formed is unstable, and thus, may adversely affect cell performance. The present inventors noticed that LiDFOB has a lower LUMO level than the first monomer, and thus can be reduced first to form a stable SEI layer, and solved the problem of unstable SEI layer formation caused by the first monomer using LiDFOB in combination with the first monomer (see FIG. 4).

In an embodiment, the electrolyte salt may further include at least one selected from the group consisting of lithium bis(trifluoromethanesulfonyl)imide (LiTFSI), lithium hexafluorophosphate (LiPF₆), lithium tetrafluoroborate (LiBF₄), LiSbF₆, LiAsF₅, LiCF₃SO₃, LiN(SO₂CF₃)₂, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCL₄, and the like.

In an embodiment, the electrolyte salt may include a first electrolyte salt that is LiDFOB and a second electrolyte salt that is different from the first electrolyte salt.

In an embodiment, the molar ratio of the first electrolyte salt to the second electrolyte salt may be 1:0 to 5, but is not limited thereto. For example, the molar ratio of the first electrolyte salt to the second electrolyte salt may be 1:0 to 5, 1:0.01 to 5, 1:0.01 to 4.5, 1:0.1 to 4.3, or 1:0.2 to 4.1, but is not limited thereto.

In an example, the electrolyte salt may be a combination of LiDFOB and LiTFSI. In an example, the molar ratio of LiDFOB to LiTFSI may be 1:0 to 5, 1:0.01 to 5, 1:0.01 to 4.5, 1:0.1 to 4.3, or 1:0.2 to 4.1, but is not limited thereto. For example, the molar ratio of LiDFOB to LiTFSI may be 10:0, 8:2, 6:4, 4:6, or 2:8, but is not limited thereto.

In an embodiment, the acrylate-based or methacrylate-based first monomer including an isocyanate group may be an acrylate-based compound including an isocyanate group, or a methacrylate-based compound including an isocyanate group.

In an embodiment, the first monomer may be a compound represented by the following Chemical Formula 1:

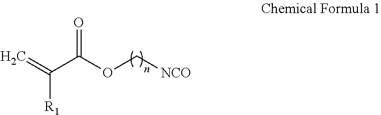

(in Chemical Formula 1,
R₁ is selected from the group consisting of hydrogen and a substituted or unsubstituted C1 to C5 alkyl group, and n is an integer from 1 to 10.).

In an embodiment, in Chemical Formula 1, R₁ may be selected from the group consisting of hydrogen and a substituted or unsubstituted C1 to C5 alkyl group. In an embodiment, in Chemical Formula 1, R₁ may be selected from the group consisting of hydrogen and a substituted or unsubstituted C1 to C3 alkyl group. In an embodiment, in Chemical Formula 1, R₁ may be selected from the group consisting of hydrogen and a substituted or unsubstituted C1 alkyl group.

In an embodiment, in Chemical Formula 1, n may be an integer from 1 to 10, n may be an integer from 1 to 9, n may be an integer from 1 to 8, n may be an integer from 1 to 7, n may be an integer from 1 to 6, n may be an integer from 1 to 5, n may be an integer from 1 to 4, n may be an integer from 1 to 3, n may be an integer from 1 to 2, n may be an integer from 2 to 3, or n may be 2, but n is not limited thereto.

In an embodiment, the first monomer may be 2-isocyanatoethyl methacrylate (ICEMA).

In an embodiment, the first monomer may be included in an amount of less than 27% by weight based on the total weight of the composition (pre-gel), but the amount is not limited thereto.

When the concentration of the first monomer is 27 wt % or more based on the total weight of the composition, there is a concern in that the gel polymer electrolyte obtained by curing the composition may become too hard and ionic conductivity is decreased. Meanwhile, such a concern may be resolved by adjusting the content of other monomers that are combined with the first monomer.

In an embodiment, the first monomer may be included in an amount of less than 27 wt %, 26 wt % or less, 25 wt % or less, 23 wt % or less, 22 wt % or less, 21 wt % or less, 20 wt % or less, 19 wt % or less, 18 wt % or less, 17 wt % or less, 16 wt % or less, 15 wt % or less, 14 wt % or less, 13 wt % or less and more than 0 wt %, 1 wt % or more, 2 wt % or more, 3 wt % or more, 4 wt % or more, 5 wt % or more, 6 wt % or more, 7 wt % or more, 8 wt % or more, 9 wt % or more, 10 wt % or more, 11 wt % or more, 12 wt % or more, 13 wt % or more, or a combination range thereof (for example: 5 to 25 wt %, more than 1 wt % and less than 27 wt %) based on the total weight of the composition (pre-gel), but the amount is not limited thereto.

In an embodiment, the first monomer may be included in an amount of 1 to 26 wt %, 5 to 26 wt %, 10 to 26 wt %, 13 to 26 wt %, or 13 to 20 wt % based on the total weight of the composition (pre-gel), but the amount is not limited thereto.

When the first monomer is included in the composition in a content within the above range, the physical properties (elasticity, strength, and the like) and ionic conductivity of a gel polymer electrolyte to be prepared, and the like may be improved.

In an embodiment, the composition for a gel polymer electrolyte may further include: a second monomer, which is an acrylate-based compound including 1 to 6 acrylate groups.

In an embodiment, the second monomer may be an acrylate-based compound including 1, 2, 3, 4, 5, or 6 acrylate groups.

In an embodiment, the second monomer may be an acrylate-based compound including 1 to 6, 1 to 5, 1 to 4, 1 to 3, or 1 to 2 acrylate groups.

In an embodiment, the second monomer may be a compound having a structure different from than that of the first monomer.

In an embodiment, the second monomer may be at least one selected from the group consisting of di(ethylene glycol) dimethacrylate (DEGDMA), polycaprolactone diacrylate, 1,6-hexanediol diacrylate, and 1,3-butanediol diacrylate, but is not limited thereto.

In an embodiment, the second monomer may be included in an amount of 20 wt % or less, 19 wt % or less, 18 wt % or less, 17 wt % or less, 16 wt % or less, 15 wt % or less, 14 wt % or less, 13 wt % or less, 12 wt % or less, 11 wt % or less, 10 wt % or less, 9 wt % or less, 8 wt % or less, 7 wt % or less, 6 wt % or less, 5 wt % or less, 4 wt % or less, 3 wt % or less, 2 wt % or less, 1 wt % or less, 0 wt % or less and 20 wt % or more, 19 wt % or more, 18 wt % or more, 17 wt % or more, 16 wt % or more, 15 wt % or more, 14 wt % or more, 13 wt % or more, 12 wt % or more, 11 wt % or more, 10 wt % or more, 9 wt % or more, 8 wt % or more, 7 wt % or more, 6 wt % or more, 5 wt % or more, 4 wt % or more, 3 wt % or more, 2 wt % or more, 1 wt % or more, 0 wt % or more, or a combination range thereof (for example: 5 to 10 wt %, 1 to 14 wt %) based on the total weight of the composition (pre-gel), but the amount is not limited thereto.

In an embodiment, the second monomer may be included in an amount of 0.1 to 20 wt %, 1 to 15 wt %, 1 to 10 wt %, or 5 to 10 wt % based on the total weight of the composition (pre-gel), but the amount is not limited thereto.

When the first monomer is included in the composition in a content within the above range, the physical properties (elasticity, strength, and the like) of a gel polymer electrolyte to be prepared may be improved.

In an embodiment, the composition for a gel polymer electrolyte may further include a solvent.

In an embodiment, the solvent may be an organic solvent, but is not limited thereto.

In an embodiment, the organic solvent may be selected from the group consisting of a carbonate-based solvent, an ester-based solvent, an ether-based solvent, and a ketone-based solvent, but is not limited thereto. In an embodiment, the organic solvent may be at least one selected from the group consisting of ethylene carbonate (EC), diethylene carbonate (DEC), acetonitrile (ACN), dipropyl carbonate (DPC), methylpropyl carbonate (MPC), ethylpropyl carbonate (EPC), ethyl methyl carbonate (EMC), dimethyl carbonate (DMC), propylene carbonate (PC), butylene carbonate (BC), fluoroethylene carbonate (FEC), vinylene carbonate (VC), γ-butyrolactone (GBL), n-methyl acetate, n-ethyl acetate, n-propyl acetate, dibutyl ether, benzene, fluorobenzene, bromobenzene, chlorobenzene, cyclohexylbenzene, isopropylbenzene, n-butylbenzene, octylbenzene, toluene, xylene, and mesitylene, but is not limited thereto. In an embodiment, the organic solvent may be EC/DEC.

In an embodiment, the composition for a gel polymer electrolyte may further include a polymerization initiator. The polymerization initiator is a typical polymerization initiator known in the art, and specifically, at least one selected from the group consisting of a UV polymerization initiator, a photopolymerization initiator, and a thermal polymerization initiator may be used. For example, the polymerization initiator may be selected from the group consisting of an azo-based initiator (for example, 2,2′-azobis(2-methylpropionitrile) (AIBN), and a peroxide-based compound (benzoyl peroxide), but is not limited thereto.

In an embodiment, the composition for a gel polymer electrolyte can be injected.

In an embodiment, the composition for a gel polymer electrolyte may be in the form of a liquid.

In an embodiment, the composition for a gel polymer electrolyte may be cured in situ or polymerized in situ.

In an embodiment, the composition for a gel polymer electrolyte may be injected into a battery and cured in situ or polymerized in situ.

### Gel Polymer Electrolyte

One aspect of the present specification provides a gel polymer electrolyte.

In an embodiment, the gel polymer electrolyte may be prepared using the above-described composition for a gel polymer electrolyte. Since the composition for a gel polymer electrolyte has been described above, a detailed description thereof will be omitted.

In an embodiment, the gel polymer electrolyte may be prepared by polymerizing the above-described composition for a gel polymer electrolyte. The polymerization may be an in situ polymerization.

In an embodiment, the gel polymer electrolyte may be prepared by curing the above-described composition for a gel polymer electrolyte. The curing may be an in situ curing.

In an embodiment, the gel polymer electrolyte may be prepared by a method including: injecting the above-described composition for a gel polymer electrolyte into a cell or a container (for example: a vial) and then curing the composition. In an embodiment, the curing may be an in situ curing. In an embodiment, the curing may be performed at 40° C. to 100° C., 50° C. to 90° C., 60° C. to 80° C., or 65° C. to 75° C., but is not limited thereto.

In an embodiment, the gel polymer electrolyte may include: an electrolyte salt including the LiDFOB; and a polymer or copolymer of the acrylate-based or methacrylate-based first monomer including an isocyanate group. Since the electrolyte salt and the first monomer have been described above, a detailed description thereof will be omitted. In an embodiment, the copolymer may be a copolymer of the acrylate-based or methacrylate-based first monomer including an isocyanate group; and a second monomer, which is an acrylate-based compound including 1 to 6 acrylate groups. Since the second monomer has been described above, a detailed description thereof will be omitted.

In an embodiment, the gel polymer electrolyte may include: an electrolyte salt including the LiDFOB; and a polymer of the acrylate-based or methacrylate-based first monomer including an isocyanate group.

In an embodiment, the gel polymer electrolyte may include an electrolyte salt including the LiDFOB; and a copolymer of i) the acrylate-based or methacrylate-based first monomer including an isocyanate group, and ii) a second monomer, which is an acrylate-based compound including 1 to 6 acrylate groups.

### Method for Preparing Gel Polymer Electrolyte

One aspect of the present specification provides a method for preparing a gel polymer electrolyte, the method including: curing the above-described composition for a polymer electrolyte (or gel polymer electrolyte).

In an embodiment, the curing step may involve curing the above-described composition for a polymer electrolyte (or gel polymer electrolyte) to form a copolymer.

In an embodiment, the curing step may involve injecting the composition for a polymer electrolyte (or gel polymer electrolyte) into a cell or a container and then curing the composition.

In an embodiment, the container may be a vial.

In an embodiment, the curing may be an in situ curing.

In an embodiment, the curing may be performed at 40° C. to 100° C., 50° C. to 90° C., 60° C. to 80° C., or 65° C. to 75° C., but is not limited thereto.

### Electrochemical Device

One aspect of the present specification provides an electrochemical device including the above-described gel polymer electrolyte. Since the gel polymer electrolyte has been described above, a detailed description thereof will be omitted.

In an embodiment, the electrochemical device may be manufactured by injecting the above-described composition for a gel polymer electrolyte into a battery. In an embodiment, the electrochemical device may be manufactured by injecting the above-described composition for a gel polymer electrolyte into a battery and curing the composition in situ.

In an embodiment, the electrochemical device may include any device that performs an electrochemical reaction, and the specific type thereof is not limited. For example, the electrochemical device may be at least one selected from the group consisting of a secondary battery (for example: a lithium secondary battery), a thermoelectric device, a capacitor, a solar cell, and a supercapacitor.

In an embodiment, the electrochemical device may further include at least one selected from the group consisting of a positive electrode, a negative electrode, and a separator. The separator may prevent short circuits between the positive electrode and the negative electrode and provide a channel for the movement of predetermined ions. The positive electrode, negative electrode, and separator are sufficient as long as they are typically used in electrochemical devices, and the specific type thereof is not limited. The positive electrode may be manufactured by applying a mixture of a positive electrode active material, a conductive material and a binder onto a current collector, and then drying the mixture. As the positive electrode active material, a transition metal oxide may be used, and the specific type thereof is not limited. The conductive material may be any material that is conductive without inducing a chemical change in the battery, and the specific type thereof is not limited. The binder may be a component that assists in the binding between the active material and the conductive material, and the like and the binding to the current collector. The negative electrode be manufactured by coating a negative electrode material onto a negative electrode current collector and drying the electrode material. The negative electrode current collector may be any material that is conductive without inducing a chemical change in the battery, and the specific type thereof is not limited. An insulating thin film with high ion permeability and mechanical strength may be used as the separator.

In an embodiment, the electrochemical device may be a cylindrical type, a prismatic type, a pouch type, a coin type, or a cable type, but is not limited thereto.

In an embodiment, the electrochemical device may further include a first electrode and a second electrode, and the gel polymer electrolyte may be disposed between the first electrode and the second electrode. The first electrode may be a positive electrode, and the second electrode may be a negative electrode.

Hereinafter, the present invention will be described in detail with reference to Examples for specifically describing the present invention. The following Examples are provided for illustrative purposes only to aid in the understanding of the present invention, and the scope and spirit of the present invention are not limited thereby.

1. Evaluation of Physical Properties of Gel Polymer Electrolytes with Different Monomer Types and Contents

### (1) Preparation of Composition for Gel Polymer Electrolyte

An electrolyte salt (LiTFSI) was mixed with an ethylene carbonate (EC)/diethylene carbonate (DEC) (volume ratio 3:7) solvent so as to be at 1 M in a composition (hereinafter, referred to as pre-gel). Thereafter, monomers ICEMA and DEGDMA were mixed at various contents, respectively (ICEMA: 0 wt %, 6 wt %, 13 wt %, 20 wt %, and 27 wt % based on the total weight of the pre-gel; DEGDMA: 0 wt %, 3 wt %, 5 wt %, 10 wt %, 15 wt %, and 20 wt based on the total weight of the pre-gel). Thereafter, AIBN was added in an amount of 0.1 wt % based on the total weight of the monomers, and then the mixture was stirred at room temperature for 2 hours. The following Table 1 discloses the monomer contents of the examples prepared. In the following Table 1, the first monomer is ICEMA and the second monomer is DEGDMA.

TABLE 1

| Classification | First monomer | | Second monomer | | Electrolyte salt |
|---|---|---|---|---|---|
| Preparation | 0 | wt % | 0 | wt % | 1.0M LiTFSI |
| Example 1 | | | | | |
| Preparation | 0 | wt % | 5 | wt % | |
| Example 2 | | | | | |
| Preparation | 0 | wt % | 10 | wt % | |
| Example 3 | | | | | |
| Preparation | 0 | wt % | 15 | wt % | |
| Example 4 | | | | | |
| Preparation | 0 | wt % | 20 | wt % | |
| Example 5 | | | | | |
| Preparation | 6 | wt % | 0 | wt % | |
| Example 6 | | | | | |
| Preparation | 6 | wt % | 5 | wt % | |
| Example 7 | | | | | |
| Preparation | 6 | wt % | 10 | wt % | |
| Example 8 | | | | | |
| Preparation | 6 | wt % | 15 | wt % | |
| Example 9 | | | | | |
| Preparation | 6 | wt % | 20 | wt % | |
| Example 10 | | | | | |
| Preparation | 13 | wt % | 0 | wt % | |
| Example 11 | | | | | |
| Preparation | 13 | wt % | 5 | wt % | |
| Example 12 | | | | | |
| Preparation | 13 | wt % | 10 | wt % | |
| Example 13 | | | | | |
| Preparation | 13 | wt % | 15 | wt % | |
| Example 14 | | | | | |
| Preparation | 13 | wt % | 20 | wt % | |
| Example 15 | | | | | |
| Preparation | 20 | wt % | 0 | wt % | |
| Example 16 | | | | | |
| Preparation | 20 | wt % | 5 | wt % | |
| Example 17 | | | | | |
| Preparation | 20 | wt % | 10 | wt % | |
| Example 18 | | | | | |
| Preparation | 20 | wt % | 15 | wt % | |
| Example 19 | | | | | |
| Preparation | 20 | wt % | 20 | wt % | |
| Example 20 | | | | | |
| Preparation | 27 | wt % | 0 | wt % | |
| Example 21 | | | | | |
| Preparation | 27 | wt % | 5 | wt % | |
| Example 22 | | | | | |
| Preparation | 27 | wt % | 10 | wt % | |
| Example 23 | | | | | |
| Preparation | 27 | wt % | 15 | wt % | |
| Example 24 | | | | | |
| Preparation | 27 | wt % | 20 | wt % | |
| Example 25 | | | | | |
| Preparation | 13 | wt % | 3 | wt % | |
| Example 26 | | | | | |

### (2) Evaluation of Elasticity of Gel Polymer Electrolyte

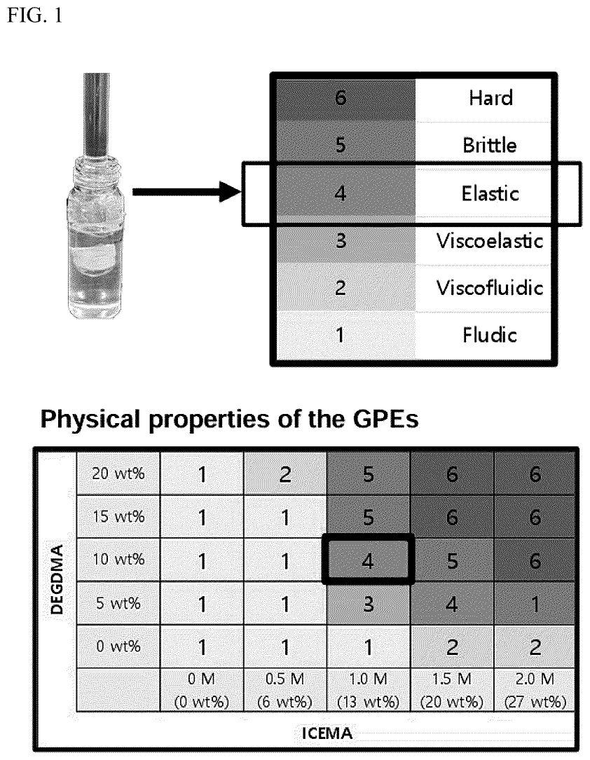

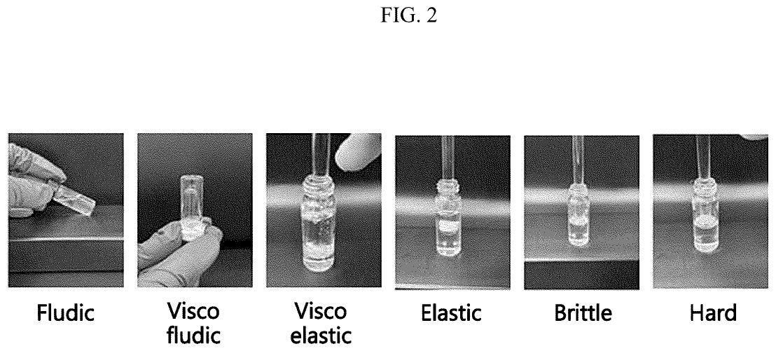

Gel polymer electrolytes were prepared by curing the pre-gels of Preparation Examples 1 to 25 in ‘1.(1) Preparation of composition for gel polymer electrolyte’ above, and the elasticity thereof was evaluated. Specifically, 3 mL of each of the pre-gels of Preparation Examples 1 to 25 was injected into a 5 mL vial, and then cured at 70° C. for 4 hours to prepare a gel polymer electrolyte. The gel polymer electrolytes prepared were pierced with a glass rod and classified into six types of physical properties (Fluidic type, Viscofluidic/Viscous type, Viscoelastic type, Elastic type, Brittle type, and Hard type) (see FIGS. 1 and 2).

1) Fluidic type is in a state close to liquid, and exhibits physical properties in which the gel polymer electrolyte flows without viscosity while not maintaining its shape. 2) Viscofluidic/Viscous type exhibits physical properties in which the gel polymer electrolyte has viscosity, flows very slowly, and temporarily maintains its shape, and the two corresponding physical properties exhibit physical properties that are closer to a liquid than to a gel. 3) Viscoelastic type exhibits properties in which the gel polymer electrolyte is adhesive and may be deformed by external force, but has a property of returning to its original shape. When a gel polymer electrolyte with the corresponding physical properties is pierced with a glass rod, the glass rod is inserted to the end of the vial with almost no resistance, and when the glass rod is removed, the gel polymer rises up while sticking to the glass rod. 4) Elastic type exhibits physical properties in which the gel polymer electrolyte may be deformed by external forces and easily returns to its original shape, but has almost no viscosity. A gel polymer electrolyte with the corresponding physical properties allows a tester to feel some resistance when pierced with a glass rod, but when the glass rod is removed, the gel polymer electrolyte immediately returns to the original state thereof without sticking to the glass rod. 5) Brittle type exhibits physical properties in which the gel polymer electrolyte may be deformed by external forces and does not easily return to its original shape. A gel polymer electrolyte with the corresponding physical properties allows a tester to feel resistance when pierced with a glass rod, and when force is applied, the structure of the gel polymer appears to break down. 6) Hard type exhibits physical properties in which the gel polymer electrolyte is hardly deformed by external forces. When a gel polymer electrolyte with the corresponding physical properties is pierced with a glass rod, the gel polymer electrolyte is too hard to penetrate into the gel polymer. The gel polymer electrolyte should not flow in order to prevent leakage of the liquid electrolyte, and should not be too hard in order to accommodate the volume expansion of an electrode. Therefore, the physical properties of the Viscoelastic type and/or Elastic type are appropriate.

As a result of the experiment, the higher the content of ICEMA and DEGDMA in the composition for a gel polymer electrolyte, the more brittle the physical properties of the gel polymer electrolyte became. In particular, it was confirmed that a polymer prepared using the pre-gel of Preparation Example 13, which contains 13 wt % of ICEMA and 10 wt % of DEGDMA, has optimal elastic characteristics for the gel polymer electrolyte (see FIG. 1).

### (3) Evaluation of Mechanical Strength (Load, Extension) of Gel Polymer Electrolyte

Load and extension were evaluated by coating each of a cellulose separator and a polyethylene (PE) separator with the pre-gel with 13 wt % of ICEMA content, which was confirmed to be one of the optimal contents in 1.(2) above. Specifically, the cellulose and PE separators were cut into pieces of 2 cm×4 cm, and then placed in aluminum pouches, and the pre-gels of Preparation Examples 12, 13, and 26 were injected. Thereafter, the pre-gel was cured at a temperature of 70° C. for 4 hours to coat the separator with the gel polymer electrolyte. Thereafter, the pouch was cut to recover the separator, and then the separator was dried in a hood in order to evaporate off electrolytic solution components such as DEC. Thereafter, the separator was attached to a jig using UTM equipment and then stretched to measure the load and extension.

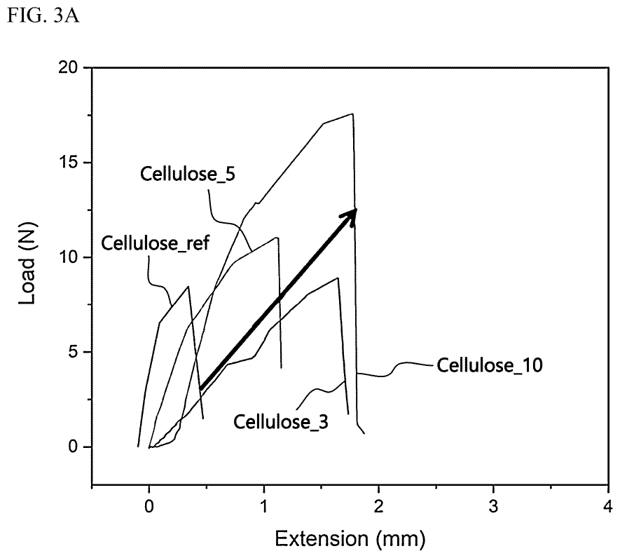

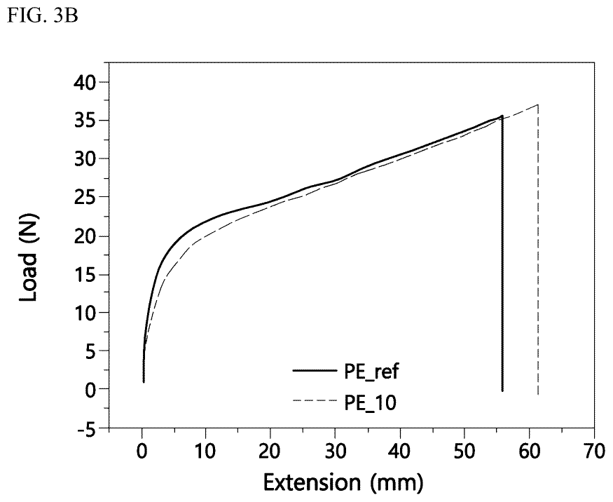

As a result of the experiment, the separators coated with the gel polymer electrolytes of Preparation Examples 12, 13, and 26 showed higher load and extension values than the separators not coated with the gel polymer electrolyte (FIGS. 3A and 3B). Through this, it could be seen that the gel polymer electrolyte of the present invention enhances the physical properties of the cellulose-based and PE-based separators. FIG. 3A shows the results of measuring the physical properties of cellulose separators coated with gel polymer electrolytes of Preparation Examples 12, 13, and 26, and cellulose separators not coated with gel polymer electrolyte. FIG. 3B shows the results of measuring the physical properties of PE separators coated with gel polymer electrolyte of Preparation Example 13, and PE separators not coated with gel polymer electrolyte.

In FIG. 3A, Cellulose_ref is a cellulose separator not coated with the gel polymer electrolyte, Cellulose_10 is a cellulose separator coated with a pre-gel including 10 wt % of DEGDMA (Preparation Example 13), Cellulose_5 is a cellulose separator coated with a pre-gel including 5 wt % of DEGDMA (Preparation Example 12), and Cellulose_3 is a cellulose separator coated with a pre-gel including 3 wt % of DEGDMA (Preparation Example 26). In FIG. 3B, PE_ref is a PE separator not coated with the gel polymer electrolyte, and PE_10 is a PE separator coated with a pre-gel including 10 wt % of DEGDMA (Preparation Example 13).

### 2. Evaluation of Battery Performance, Electrolyte Decomposition Behavior, and Ionic Conductivity According to Type and Content of Electrolyte Salt

### (1) Preparation of Composition for Gel Polymer Electrolyte

An electrolyte salt (LiDFOB+LiTFSI (molar ratio of LiDFOB:LiTFSI is 10:0, 8:2, 6:4, 4:6, 2:8, or 0:10), or LiBF₄) was mixed with an ethylene carbonate (EC)/diethylene carbonate (DEC) (volume ratio 3:7) solvent, such that the molar concentration of the entire lithium salt in the pre-gel was 1 M, and monomers ICEMA and DEGDMA were mixed in an amount of 13 wt % and 1.5 wt %, respectively, based on the total weight of the pre-gel. Thereafter, AIBN was added in an amount of 0.1 wt % based on the total weight of the monomers, and then the mixture was stirred at room temperature for 2 hours. The monomer contents and the types and contents of electrolyte salts in the Preparation Examples are disclosed in the following Table 2. In the following Table 2, the first monomer is ICEMA and the second monomer is DEGDMA.

TABLE 2

| Classifi- | First | Second | |
|---|---|---|---|
| cation | monomer | monomer | Electrolyte salt |
| Preparation | 13 wt % | 1.5 wt % | LiDFOB (Molar ratio of |
| Example 27 | | | LiTFSI:LiDFOB of 0:10) |
| Preparation | | | LiTFSI and LiDFOB (Molar ratio |
| Example 28 | | | of LiTFSI:LiDFOB of 2:8) |
| Preparation | | | LiTFSI and LiDFOB (Molar ratio |
| Example 29 | | | of LiTFSI:LiDFOB of 4:6) |
| Preparation | | | LiTFSI and LiDFOB (Molar ratio |
| Example 30 | | | of LiTFSI:LiDFOB of 6:4) |
| Preparation | | | LiTFSI and LiDFOB (Molar ratio |
| Example 31 | | | of LiTFSI:LiDFOB of 8:2) |
| Preparation | | | LiTFSI (Molar ratio of |
| Example 32 | | | LiTFSI:LiDFOB of 10:0) |

### (2) Evaluation of Capacity and Coulombic Efficiency

The capacity changes of the cells to which the gel polymer electrolytes prepared using the Preparation Example pre-gels (Preparation Examples 27 to 32) in 2.(2) above were applied were evaluated. Specifically, a three-electrode cell of NCM|Graphite|Graphite (working/reference/counter electrode) was assembled with a PE separator to manufacture an assembled battery. The pre-gel in the Preparation Example was injected into the assembled battery. Thereafter, an aging process of leaving the electrode to stand under a temperature condition of 22° C. for 18 hours, so that the pre-gel was thoroughly impregnated into the active material of the coated electrode. Thereafter, the pre-gel was cured under a temperature condition of 70° C. for 4 hours to convert the pre-gel into a copolymer inside the cell. Each of the manufactured cells was CC-charged at 0.15 C (1 mA) to a voltage of 4.45 V under a temperature condition of 22° C., and then CV-charged to maintain the voltage at 4.45 V. The CV cut off condition was set to 0.2 mA, and the battery was then discharged at 0.15 C (1 mA) to 3.0 V to measure a discharge capacity. Thereafter, the above process was repeated once more to measure the discharge capacity, and the initial coulombic efficiency (the rate of discharge capacity retention compared to the initial charge capacity) was evaluated as a ratio between the two capacities.

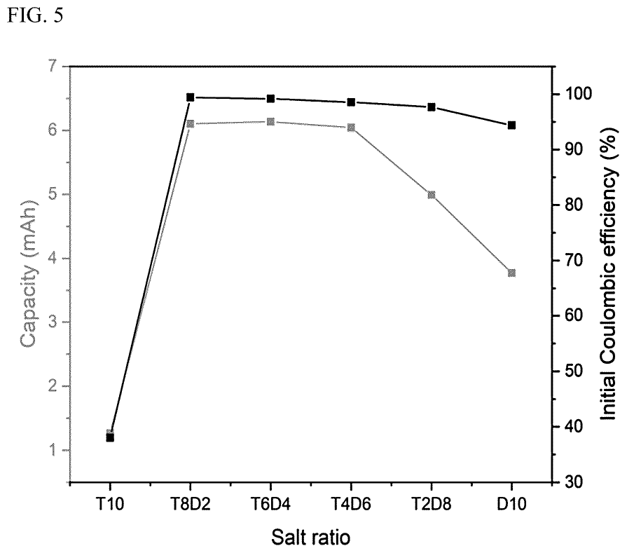

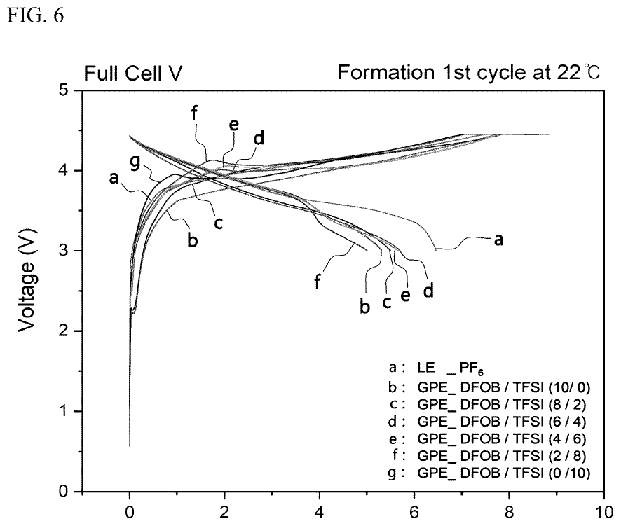

As a result of the experiment, the gel polymer electrolyte cell manufactured using the pre-gel of Preparation Example 32, which did not include LiDFOB and used only LiTFSI as an electrolyte salt, showed a very low initial discharge capacity, and the initial coulombic efficiency also showed a very low value at a level of 40%. Conversely, gel polymer electrolyte cells manufactured using the pre-gels of Preparation Examples 27 to 31 including LiDFOB showed higher initial discharge capacities and an initial coulombic efficiency of 90% or more (see FIGS. 5 and 6). Through this, it was confirmed that the gel polymer electrolyte (GPE) prepared using the gel polymer electrolyte composition (pre-gel) of the present invention can solve the problem of performance degradation caused by the formation of an unstable SEI layer of ICEMA, and can exhibit higher capacity and initial coulombic efficiency. In other words, it was confirmed that a gel polymer electrolyte composition including LiDFOB as an electrolyte salt can improve cell performance (charge/discharge capacity, coulombic efficiency, and the like) compared to a composition not including LiDFOB.

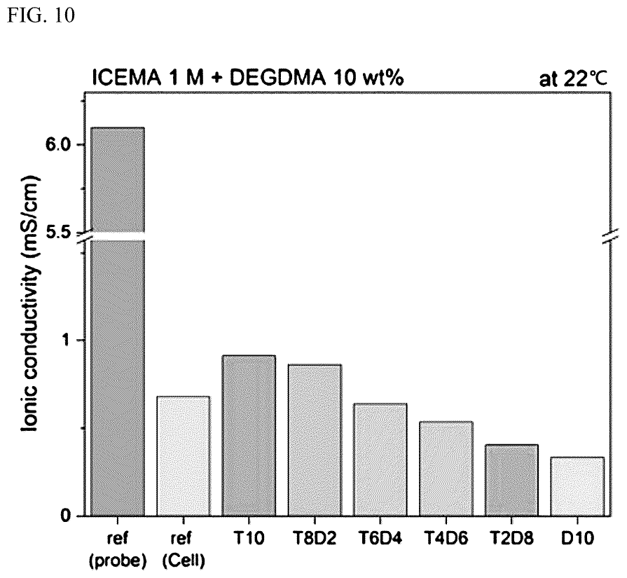

In FIGS. 5 and 10, T10 is a cell to which the gel polymer electrolyte prepared using Preparation Example 32 including only LiTFSI as an electrolyte salt is applied, T8D2 is a cell to which the gel polymer electrolyte prepared using Preparation Example 31 including LiTFSI and LiDFOB at a molar ratio of 8:2 is applied, T6D4 is a cell to which the gel polymer electrolyte prepared using Preparation Example 30 including LiTFSI and LiDFOB at a molar ratio of 6:4 is applied, T4D6 is a cell to which the gel polymer electrolyte prepared using Preparation Example 29 including LiTFSI and LiDFOB at a molar ratio of 4:6 is applied, T2D8 is a cell to which the gel polymer electrolyte prepared using Preparation Example 28 including LiTFSI and LiDFOB at a molar ratio of 2:8 is applied, and D10 is a cell to which the gel polymer electrolyte prepared using Preparation Example 27 including only LiDFOB as an electrolyte salt is applied. In addition, in FIG. 10, ref (Cell) is a cell to which a commercial reference electrolyte (control electrolyte) is applied, which is a cell to which a liquid electrolyte including an EC/DEC solvent and 1 M LiPF₆ is applied. Furthermore, in FIG. 10, ref (probe) is the conductivity value for the reference electrolyte (control electrolyte) analyzed by a commercially available probe type ionic conductivity meter, and an ionic conductivity value measured in a cell including a PE separator using this reference electrolyte (control electrolyte) is a value corresponding to ref (cell).

In FIGS. 6 to 9, GPE_DFOB/TSFI(0/10) is a cell to which the gel polymer electrolyte prepared using Preparation Example 32 including only LiTFSI as an electrolyte salt is applied, GPE_DFOB/TSFI(2/8) is a cell to which the gel polymer electrolyte prepared using Preparation Example 31 including LiTFSI and LiDFOB at a molar ratio of 8:2 is applied, GPE_DFOB/TSFI(4/6) is a cell to which the gel polymer electrolyte prepared using Preparation Example 30 including LiTFSI and LiDFOB at a molar ratio of 6:4 is applied, GPE_DFOB/TSFI(6/4) is a cell to which the gel polymer electrolyte prepared using Preparation Example 29 including LiTFSI and LiDFOB at a molar ratio of 4:6 is applied, GPE_DFOB/TSFI(8/2) is a cell to which the gel polymer electrolyte prepared using Preparation Example 28 including LiTFSI and LiDFOB at a molar ratio of 2:8 is applied, and GPE_DFOB/TSFI(10/0) is a cell to which the gel polymer electrolyte prepared using Preparation Example 27 including only LiDFOB as an electrolyte salt is applied. Furthermore, LE_PF₆ is a cell to which a commercial reference electrolyte (control electrolyte), which is a cell to which a liquid electrolyte including an EC/DEC solvent and 1 M LiPF₆ is applied.

### (3) Evaluation of Electrolyte Decomposition Behavior During Initial Charging

The electrolyte decomposition behavior during initial charging of cells to which the gel polymer electrolytes prepared using the Preparation Example pre-gels (Preparation Examples 27 to 32) in 2.(2) above was evaluated. Specifically, in the first charging graph conducted in the graphite electrode, Data (dQ/dE) obtained by dividing the capacity change (dQ) by the voltage change (dE) was analyzed according to the electrolyte conditions.

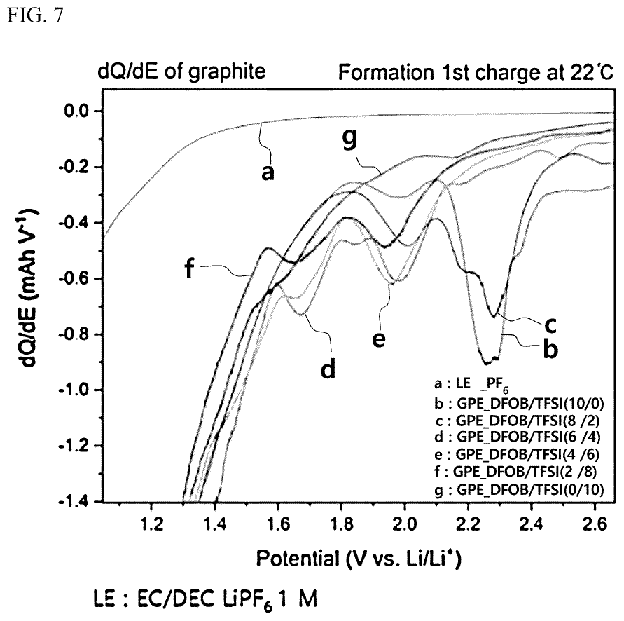

As a result of the experiment, the cell to which the existing commercial liquid electrolyte (LE_PF₆) was applied showed a small reduction peak at around 1.2 V compared to the lithium electrode. In contrast, the cell to which the gel polymer electrolyte including the LiDFOB electrolyte salt showed a reduction peak at around 2.0 to 2.2 V compared to the lithium electrode. The cell to which the gel polymer electrolyte not including the LiDFOB electrolyte salt was applied showed no reduction peak at 2.0 V to 2.2 V. Through this, it can be seen that the LiDFOB electrolyte salt is reduced prior to the other electrolytes (see FIG. 7). Further, it can be expected that a stable SEI layer was formed as charge and discharge proceeded smoothly in the cell to which the gel polymer electrolyte including the LiDFOB electrolyte salt was applied.

### (4) Evaluation of Impedance

The impedances of the cells to which the gel polymer electrolytes prepared using the Preparation Example pre-gels (Preparation Examples 27 to 31) in 2.(2) above were applied were evaluated. Specifically, the cell to which the gel polymer electrolyte was applied, which had been subjected to a charge-discharge experiment in triplicate, was charged up to 4.45 V using an impedance analyzer, and then impedance was measured from 1 MHz to 10 MHz at an amplitude of 10 mV.

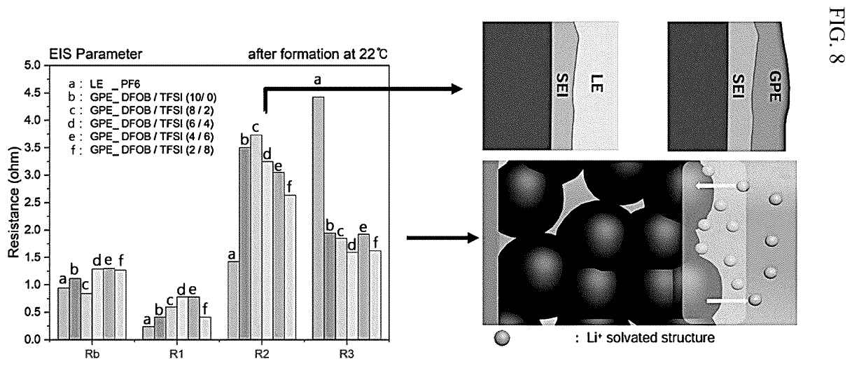

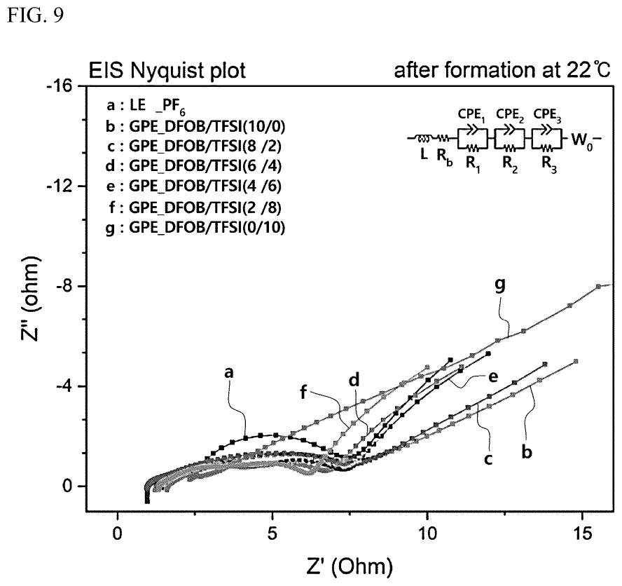

As a result of the experiment, the gel polymer electrolytes prepared using the compositions for gel polymer electrolyte of the present invention (Preparation Examples 27 to 31) exhibited significantly higher film resistance (R₂) values than the reference electrolyte (LE_PF₆). In addition, as the content of LiDFOB increased, the film resistance increased due to the decrease in the dissolved structure of LiDFOB. Through the change in film resistance values as described above, it could be seen that the SEI at the graphite interface was modified. Furthermore, the gel polymer electrolytes prepared using the compositions for gel polymer electrolyte of the present invention (Preparation Examples 27 to 31) exhibited significantly lower charge transfer resistance (R₃) values than the reference electrolyte (LE_PF₆) (see FIGS. 8 and 9). Since the solvated structure of the lithium salt is present in the polymer matrix under the gel polymer electrolyte condition, it appears that the charge transfer resistance is reduced compared to the liquid electrolyte.

In consideration of the operating principle of lithium secondary batteries, where lithium ions should pass through the SEI during electrochemical reactions in which they are repeatedly oxidized and reduced by charging and discharging, a lithium ion battery with strong durability (particularly at high temperatures) may be implemented only when an SEI having a certain level or more of film resistance (R₂) is present. Further, the charge transfer resistance (R₃) value is an index that is directly related to a resistance required for oxidation and reduction, and a lower R₃ value is electrochemically advantageous. Therefore, the gel polymer electrolyte of the present invention, which has a high R₂ value and a low R₃ value compared to the reference electrolyte (LE_PF₆), may be considered to exhibit characteristics that are advantageous to be applied to lithium ion batteries.

Through the above experimental results, it was confirmed that a gel polymer electrolyte composition including LiDFOB as an electrolyte salt can form a more stable SEI layer than a composition not including LiDFOB.

### (5) Evaluation of Ionic Conductivity

The ionic conductivities of the PE separators to which the gel polymer electrolytes prepared using the Preparation Example pre-gels (Preparation Examples 27 to 32) in 2.(2) above were applied were evaluated.

Specifically, a copper sheet and a PE separator were used to inject the pre-gel into a Cu|PE|Cu pouch assembled battery. The pre-gel was cured under a temperature condition of 70° C. for 4 hours to convert the pre-gel into a copolymer in the cell. Thereafter, impedance was measured according to the change in the frequency from 1 MHz to 100 Hz, and a Rb value was measured. Ionic conductivity was calculated through the Rb value, the distance between the electrodes, and the area of the electrode.

As a result of the experiment, it was confirmed that the gel polymer electrolyte of the present invention exhibited similar or higher ionic conductivity than the liquid reference electrolyte. As the proportion of LiTFSI in the electrolyte salt included in the pre-gel increased, the ionic conductivity of the gel polymer electrolyte increased, and gel polymer electrolytes with a LiTFSI proportion of 60 mol % or more exhibited higher ionic conductivity than the reference electrolyte (see FIG. 10). Meanwhile, the cell to which the pre-gel including only LiDFOB as an electrolyte salt was applied also exhibited a certain level or more of ionic conductivity.

### 3. Evaluation of Charge/Discharge Behavior According to Concentration of First Monomer

### (1) Preparation of Composition for Gel Polymer Electrolyte

An electrolyte salt (LiTFSI+LiDFOB (molar ratio of LiTFSI:LiDFOB of 6:4) was mixed with an ethylene carbonate (EC)/diethylene carbonate (DEC) (volume ratio 3:7) solvent, such that the molar concentration of the entire lithium salt in the pre-gel was 1 M, and monomers ICEMA (13 wt %, 20 wt %, 27 wt %, and 34 wt % based on the total weight of the pre-gel) and DEGDMA (10 wt % based on the weight of ICEMA) were mixed. Thereafter, AIBN was added in an amount of 0.1 wt % based on the total weight of the monomers, and then the mixture was stirred at room temperature for 2 hours. The following Table 3 discloses the contents of the first monomers in the Preparation Examples. In the following Table 3, the first monomer is ICEMA and the second monomer is DEGDMA.

TABLE 3

| | First | Second | |
|---|---|---|---|
| Classification | monomer | monomer | Electrolyte salt |
| Preparation | 13 wt % | 10% | LiTFSI and LiDFOB |
| Example 33 | | compared | (Molar ratio of LiTFSI:LiDFOB |
| Preparation | 20 wt % | to weight | of 6:4) |
| Example 34 | | of first | |
| Preparation | 27 wt % | monomer | |
| Example 35 | | | |
| Preparation | 34 wt % | | |
| Example 36 | | | |

### (2) Evaluation of Charge/Discharge Behavior

The charge/discharge behaviors of the cells to which the gel polymer electrolytes prepared using the Preparation Example pre-gels (Preparation Examples 33 to 36) in 3.(1) above were applied were evaluated. Specifically, a NCM|Graphite|Graphite 3-electrode cell (working electrode/reference electrode/counter electrode) was assembled with a PE separator to manufacture an assembled battery. After the pre-gel was injected into the assembled battery, an aging process of leaving the electrode to stand under a temperature condition of 22° C. for 18 hours, so that the pre-gel was thoroughly impregnated into the active material of the coated electrode. Thereafter, the pre-gel was cured under a temperature condition of 70° C. for 4 hours to convert the pre-gel into a copolymer inside the cell. Each of the manufactured cells was CC-charged at 0.15 C (1 mA) to a voltage of 4.45 V under a temperature condition of 22° C., and then CV-charged to maintain the voltage at 4.45 V. The CV cut off condition was set to 0.2 mA, and the battery was then discharged at 0.15 C (1 mA) to 3.0 V to measure the discharge capacity.

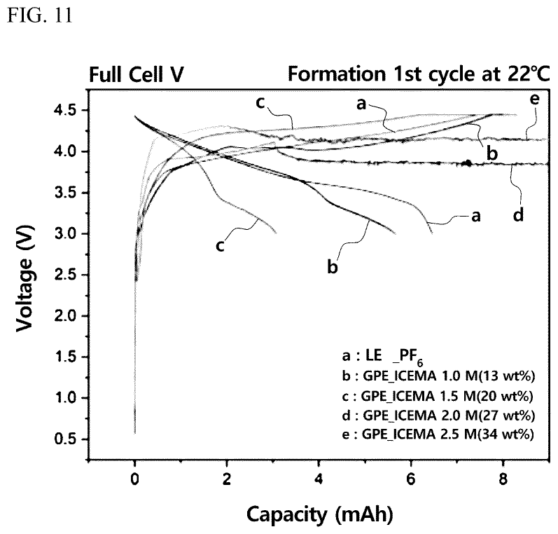

As a result of the experiment, the cell to which the gel polymer electrolyte composition with an ICEMA concentration of 1.5 M (20 wt %) or less exhibited an excellent charge/discharge behavior. Meanwhile, the cells to which the gel polymer electrolyte composition with an ICEMA concentration of 2.0 M (27 wt %) or more was applied did not reach a charge voltage until 4.45 V and exhibited an abnormal charge behavior (see FIG. 11). Through the above experimental results, it could be seen that a composition for a gel polymer electrolyte with an ICEMA concentration of 1.5 M (20 wt %) or less can exhibit excellent physical properties and/or ionic conductivity. However, since the corresponding experiment was conducted with the amount of DEGDMA fixed at a specific ratio to the amount of ICEMA, it appears that there is room for exhibiting an effect of improvements in physical properties and ionic conductivity even at an ICEMA concentration of 2.0M or more by adjusting the content of DEGDMA.

In FIG. 11, GPE_ICEMA 1.0 M (13 wt %) is a cell to which Preparation Example 33 is applied, in which ICEMA is included at 1 M (13 wt % based on the total weight of the composition), GPE_ICEMA 1.5 M (20 wt %) is a cell to which Preparation Example 34 is applied, in which ICEMA is included at 1.5 M (20 wt % based on the total weight of the composition), GPE_ICEMA 2.0 M (27 wt %) is a cell to which Preparation Example 35 is applied, in which ICEMA is included at 2.0 M (27 wt % based on the total weight ratio of the composition), and GPE_ICEMA 2.5 M (34 wt %) is a cell to which Preparation Example 36 is applied, in which ICEMA is included at 2.5 M (34 wt % based on the total weight ratio of the composition). LE_PF₆ is a cell to which a commercial reference electrolyte (control electrolyte), and specifically, is a cell to which a liquid electrolyte including an EC/DEC solvent and 1 M LiPF₆ is applied.

4. Evaluation of Initial Charge/Discharge Behavior of Three-Electrode Pouch Cells to which Gel Polymer Electrolytes with Different Types of Electrolyte Salts are Applied

### (1) Preparation of Composition for Gel Polymer Electrolyte

An electrolyte salt (LiTFSI+LiDFOB or LiPF6+LiDFOB; molar ratio of 10:0 or molar ratio of 4:6) was mixed with an EC/acetonitrile (ACN) (volume ratio 3:7) solvent, such that the molar concentration of the entire lithium salt became 1 M, and a monomer ICEMA was mixed at 1 M (13 wt % based on the total weight of the pre-gel) was mixed. Thereafter, AIBN was added in an amount of 0.1 wt % based on the total weight of the monomers, and then the mixture was stirred at room temperature for 2 hours. The monomer contents and the types and contents of electrolyte salts in the prepared Preparation Examples are disclosed in the following Table 4. In the following Table 4, the first monomer is ICEMA.

TABLE 4

| Classifi- | First | Second | |
|---|---|---|---|
| cation | monomer | monomer | Electrolyte salt |
| Preparation | 13 wt % | 0 wt % | LiPF₆ (Molar ratio of |
| Example 37 | | | LiPF₆:LiDFOB of 10:0) |
| Preparation | 13 wt % | | LiPF₆ and LiDFOB (Molar ratio |
| Example 38 | | | of LiPF₆:LiDFOB of 4:6) |
| Preparation | 13 wt % | | LiTFSI (Molar ratio of |
| Example 39 | | | LiTFSI:LiDFOB of 10:0) |
| Preparation | 13 wt % | | LiTFSI and LiDFOB (Molar ratio |
| Example 40 | | | of LiTFSI:LiDFOB of 4:6) |

### (2) Evaluation of Charge/Discharge Behavior

The charge/discharge behaviors of the cells to which the gel polymer electrolytes prepared using the Preparation Example pre-gels (Preparation Examples 37 to 40) in 4.(1) above were applied were evaluated. Specifically, a three-electrode cell of NCM|Graphite|Graphite was assembled with a PE separator to manufacture an assembled battery. After the pre-gel was injected into the assembled battery, an aging process of leaving the electrode to stand under a temperature condition of 22° C. for 18 hours, so that the pre-gel was thoroughly impregnated into the active material of the coated electrode. Thereafter, the pre-gel was cured under a temperature condition of 70° C. for 4 hours to convert the pre-gel into a copolymer inside the cell. Each of the manufactured cells was CC-charged at 0.15 C (1 mA) to a voltage of 4.45V under a temperature condition of 22° C., and then CV-charged to maintain the voltage at 4.45V. The CV cut off condition was set to 0.2 mA, and the battery was then discharged at 0.15 C (1 mA) to 3.0 V to measure a discharge capacity.

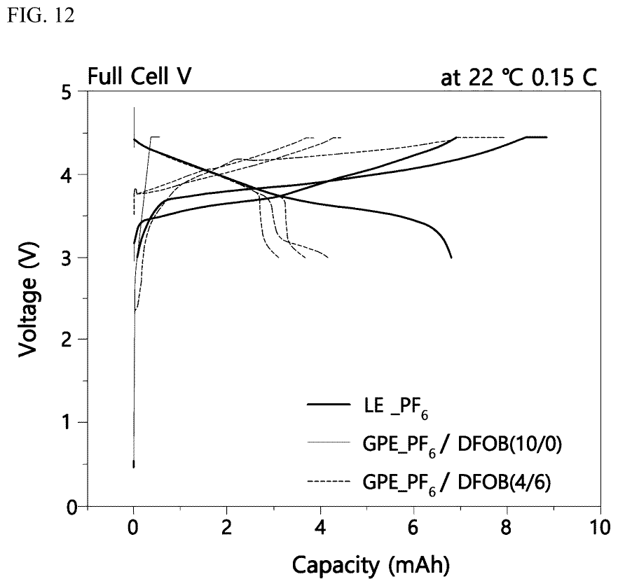

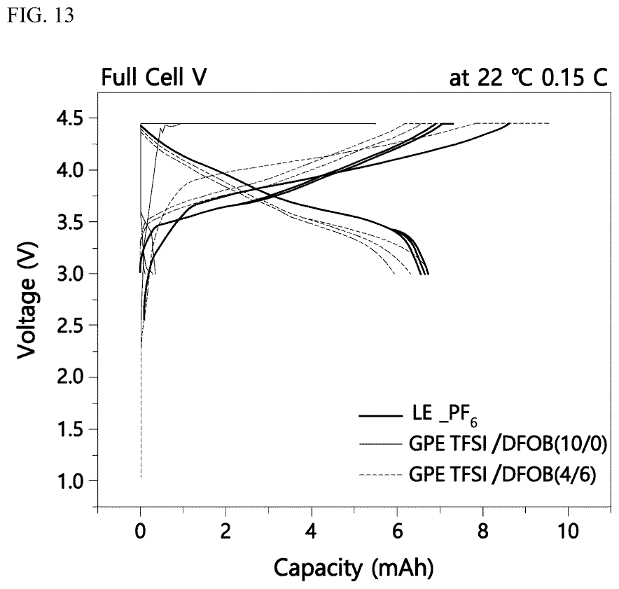

As a result of the experiment, the gel polymer electrolyte cells manufactured using the compositions for gel polymer electrolyte (Preparation Examples 37 and 39) including only LiTFSI or LiPF₆ as an electrolyte salt without including LiDFOB as the electrolyte salt exhibited a very small initial capacity. Meanwhile, the gel polymer electrolyte cells prepared by including LiDFOB as the electrolyte salt exhibited high initial capacity (Preparation Examples 38 and 40) (see FIGS. 12 and 13). Through this, it can be seen that LiDFOB can exhibit an effect of improving cell performance even though used not only with LiTFSI, but also with other lithium salts. In addition, it can be seen that LiDFOB can exhibit an effect of improving cell performance not only in an EC/DEC solvent, but also in other solvents.

In FIG. 12, GPE_PF₆/DFOB(10/0) is a cell to which the gel polymer electrolyte using Preparation Example 37 including only LiPF₆ as an electrolyte salt is applied, and GPE_PF₆/DFOB(4/6) is a cell to which the gel polymer electrolyte using Preparation Example 38 including LiPF₆ and LiDFOB at a molar ratio of 4:6 is applied. In FIG. 13, GPE_TFSI/DFOB(10/0) is a cell to which the gel polymer electrolyte using Preparation Example 39 including only LiTFSI as an electrolyte salt is applied, and GPE_TFSI/DFOB(4/6) is a cell to which the gel polymer electrolyte using Preparation Example 40 including LiTFSI and LiDFOB at a molar ratio of 4:6 is applied. In FIGS. 12 and 13, LE_PF₆ is a cell to which a commercial reference electrolyte (control electrolyte) is applied, and specifically, is a cell to which a liquid electrolyte including an EC/DEC solvent and 1 M LiPF₆ is applied.

Through the above experimental results, it was confirmed that a gel polymer electrolyte composition including an acrylate-based or methacrylate-based monomer including an isocyanate group (for example: ICEMA) can improve cell performance (charge/discharge capacity, coulombic efficiency, and the like), and simultaneously can form a stable SEI layer by including LiDFOB as an electrolyte salt, compared to a gel polymer electrolyte composition not including LiDFOB. In addition, it was confirmed that the physical properties could be further improved using an acrylate-based or methacrylate-based monomer including an isocyanate group together with another acrylate-based monomer including an acrylate group.

### EMBODIMENTS

Embodiment 1: A precursor composition of a gel polymer electrolyte, including: an electrolyte salt including lithium difluoro (oxalato) borate (LiDFOB); and a first monomer selected from an acrylate-based compound including an isocyanate group or a methacrylate-based compound including an isocyanate group.

Embodiment 2: The precursor composition of the gel polymer electrolyte of Embodiment 1, wherein the electrolyte salt further includes at least one selected from the group consisting of lithium bis(trifluoromethanesulfonyl)imide (LiTFSI), lithium hexafluorophosphate (LiPF₆), lithium tetrafluoroborate (LiBF₄), LiSbF₆, LiAsF₅, LiCF₃SO₃, LiN(SO₂CF₃)₂, LiN(SO₂CF₃)₂, LiN(SO₂C₂F₅)₂, LiC(SO₂CF₃)₃, LiN(SO₃CF₃)₂, LiC₄F₉SO₃, LiAlO₄, and LiAlCL₄.

Embodiment 3: The precursor composition of the gel polymer electrolyte of Embodiment 1 or 2, wherein the first monomer is a compound represented by the following Chemical Formula 1:

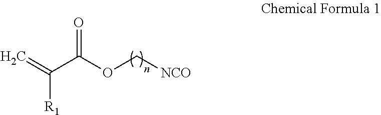

(in Chemical Formula 1,
R₁ is selected from the group consisting of hydrogen and a substituted or unsubstituted C1 to C5 alkyl group, and n is an integer from 1 to 10.).

Embodiment 4: The precursor composition of the gel polymer electrolyte of any one of Embodiments 1 to 3,
wherein the first monomer is 2-isocyanatoethyl methacrylate.

Embodiment 5: The precursor composition of the gel polymer electrolyte of any one of Embodiments 1 to 4, wherein the first monomer is included in an amount of 1 to 26 wt % based on the total weight of the composition.

Embodiment 6: The precursor composition of the gel polymer electrolyte of any one of Embodiments 1 to 5, further including: a second monomer, which is an acrylate-based compound including 1 to 6 acrylate groups.

Embodiment 7: The precursor composition of the gel polymer electrolyte of Embodiment 6, wherein the second monomer is di(ethylene glycol) dimethacrylate.

Embodiment 8: The precursor composition of the gel polymer electrolyte of any one of Embodiments 6 to 7, wherein the second monomer is included in an amount of 1 to 10 wt % based on the total weight of the composition.

Embodiment 9: A gel polymer electrolyte prepared using the precursor composition of the gel polymer electrolyte of any one of Embodiments 1 to 8.

Embodiment 10: An electrochemical device comprising: the gel polymer electrolyte of Embodiment 9.

Embodiment 11: A method for preparing a gel polymer electrolyte, the method including: curing the precursor composition of the gel polymer electrolyte of any one of Embodiments 1 to 8.

What is claimed is:

1. A precursor composition of a gel polymer electrolyte, comprising: an electrolyte salt comprising lithium difluoro (oxalato) borate (LiDFOB); and a first monomer selected from an acrylate-based compound comprising an isocyanate group or a methacrylate-based compound comprising an isocyanate group.

2. The precursor composition of the gel polymer electrolyte of claim 1, wherein the electrolyte salt further comprises at least one selected from the group consisting of lithium bis(trifluoromethanesulfonyl)imide (LiTFSI), lithium hexafluorophosphate (LiPF₆), lithium tetrafluoroborate (LiBF₄), LiSbF₆, LiAsF₅, LiCF₃SO₃, LiN(SO₂CF₃)₂, LiN(SO₂CF₃)₂, LiN(SO₂C₂F₅)₂, LiC(SO₂CF₃)₃, LiN(SO₃CF₃)₂, LiC₄F₉SO₃, LiAlO₄, and LiAlCL₄.

3. The precursor composition of the gel polymer electrolyte of claim 1, wherein the first monomer is a compound represented by the following Chemical Formula 1: 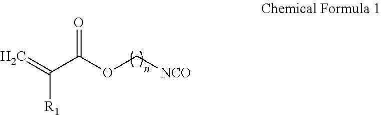
wherein,
R₁ is selected from the group consisting of hydrogen and a substituted or unsubstituted C1 to C5 alkyl group, and n is an integer from 1 to 10.

4. The precursor composition of the gel polymer electrolyte of claim 1, wherein the first monomer is 2-isocyanatoethyl methacrylate.

5. The precursor composition of the gel polymer electrolyte of claim 1, wherein the first monomer is comprised in an amount of 1 to 26 wt % based on a total weight of the composition.

6. The precursor composition of the gel polymer electrolyte of claim 1, further comprising: a second monomer, which is an acrylate-based compound comprising 1 to 6 acrylate groups.

7. The precursor composition of the gel polymer electrolyte of claim 6, wherein the second monomer is di(ethylene glycol) dimethacrylate.

8. The precursor composition of the gel polymer electrolyte of claim 6, wherein the second monomer is comprised in an amount of 1 to 10 wt % based on the total weight of the composition.

9. A gel polymer electrolyte prepared using the precursor composition of the gel polymer electrolyte of claim 1.

10. An electrochemical device comprising the gel polymer electrolyte of claim 9.

11. A method for preparing a gel polymer electrolyte, the method comprising: curing the precursor composition of the gel polymer electrolyte of claim 1.
